(19) United States
(12) Patent Application Publication
(10) Pub. No.: US 2024/0251875 A1
(43) Pub. Date: Aug. 1, 2024

(54) AEROSOL-GENERATING DEVICE AND METHOD OF CONTROLLING TEMPERATURE OF HEATER OF THE AEROSOL-GENERATING DEVICE

(71) Applicant: KT&G CORPORATION, Daejeon (KR)

(72) Inventors: Yong Hwan KIM, Gyeonggi-do (KR); Dong Sung KIM, Seoul (KR); Seung Won LEE, Gyeonggi-do (KR); Seok Su JANG, Daejeon (KR); Dae Nam HAM, Seoul (KR)

(73) Assignee: KT&G CORPORATION, Daejeon (KR)

(21) Appl. No.: 18/565,434

(22) PCT Filed: Jun. 22, 2022
(86) PCT No.: PCT/KR2022/008843

§ 371 Date: Nov. 29, 2023

(30) Foreign Application Priority Data
Jun. 29, 2021 (KR) 10-2021-0085043

(51) Int. Cl. A24F 40/57; A24F 40/20; A24F 40/53; H05B 1/02

(52) U.S. Cl. CPC A24F 40/57; A24F 40/20; A24F 40/53; H05B 1/0227

(57) ABSTRACT

Provided is an aerosol-generating device including a heater configured to generate an aerosol by heating an aerosol-generating material of a cigarette, and a controller configured to determine whether the cigarette inserted through a cigarette insertion hole is a wet cigarette, and control the temperature of the heater based on a dedicated temperature profile corresponding to the wet cigarette when it is detected that the inserted cigarette is a wet cigarette.

### TECHNICAL FIELD

The present disclosure relates to an aerosol-generating device and a method of controlling the temperature of a heater of the aerosol-generating device, and more particularly, to a general-purpose aerosol-generating device capable of operating normally regardless of the type of a cigarette inserted thereinto and a method of controlling the temperature of a heater of the aerosol-generating device.

### BACKGROUND ART

In recent years, there has been increasing demand for alternatives to conventional cigarettes. For example, there is increasing demand for an aerosol-generating device that generates an aerosol by heating an aerosol-generating material in a cigarette without combustion. Accordingly, studies on heating-type cigarettes or heating-type aerosol-generating devices have been actively conducted.

A cigarette exposed to excessive moisture in an aerosol-generating device may be referred to as a wet cigarette or an over-moisture cigarette. In general, the moisture (moisture content) in a regular cigarette is 11% to 12%. Cigarettes with a moisture content greater than 12% may be classified as wet cigarettes, and cigarettes with a moisture content greater than 14% may be classified as over-moisture cigarettes. Hereinafter, a cigarette having a moisture content greater than that of a regular cigarette will be referred to as a wet cigarette.

There are several cases where a regular cigarette turns into a wet cigarette. For example, when a cigarette pack storing cigarettes is not sufficiently dried after being directly immersed in water due to a user's mistake, the cigarettes in the cigarette pack may become wet cigarettes. As another example, when a cigarette is not stored in a cool place in a country or region during the rainy season or a rainy period, the moisture content of the cigarette may continuously increase due to high humidity, and thus a regular cigarette may turn into a wet cigarette.

### DISCLOSURE OF INVENTION

### Technical Problem

When a wet cigarette is used in an aerosol-generating device, a normal operation of the aerosol-generating device may be impossible due to the high moisture content. For example, the aerosol may be overly heated.

An objective of the present disclosure is to provide an aerosol-generating device that stably generates an aerosol at a proper temperature even when a wet cigarette is used, and a method of controlling the temperature of a heater of the aerosol-generating device.

### Solution to Problem

An aerosol-generating device according to an embodiment of the present disclosure includes: a heater that heats an aerosol-generating material of a cigarette; and a controller that determines whether the cigarette inserted through a cigarette insertion hole is a wet cigarette, and controls a temperature of the heater based on a dedicated temperature profile corresponding to the wet cigarette when it is determined that the inserted cigarette is a wet cigarette.

The controller may determine whether the inserted cigarette is a wet cigarette when a first time has elapsed since the heater started to be heated based on a preset first temperature profile.

The controller may determine whether the inserted cigarette is a wet cigarette based on a temperature increase rate of the heater when a first time has elapsed since the heater started to be heated.

The controller may determine whether the inserted cigarette is a wet cigarette based on the temperature of the heater when a first time has elapsed since the heater started to be heated.

The aerosol-generating device may further include at least one capacitor disposed adjacent to the cigarette insertion hole such that capacitance of the capacitor varies with an amount of moisture in the cigarette inserted into the cigarette insertion hole, wherein the controller may determine whether the inserted cigarette is a wet cigarette based on the capacitance.

When it is determined that the inserted cigarette is a wet cigarette, the controller may select one of a plurality of preset dedicated temperature profiles according to an amount of moisture contained in the cigarette.

The controller may detect a time of recent use of the aerosol-generating device, and based on the time of recent use being within a certain time period, control the temperature of the heater based on a second dedicated temperature profile that is different from the dedicated temperature profile.

The controller may detect the time of recent use based on the temperature of the heater at the time the cigarette is inserted.

The controller may control the temperature of the heater based on the second dedicated temperature profile if the temperature of the heater at the time the cigarette is inserted is in the range of about 50 degrees Celsius to about 150 degrees Celsius.

The dedicated temperature profile may be calculated by adjusting a basic temperature profile for a regular cigarette.

The dedicated temperature profile may be calculated by delaying a point in time when the temperature of the heater reaches a maximum value in the basic temperature profile.

A method of controlling a temperature of a heater of an aerosol-generating device, according to an embodiment of the present disclosure includes: detecting that a cigarette is inserted into a cigarette insertion hole; determining whether the inserted cigarette is a wet cigarette; and when it is determined that the inserted cigarette is a wet cigarette, controlling the temperature of the heater with a dedicated temperature profile corresponding to the wet cigarette.

The method may further include detecting a time of recent use of the aerosol-generating device, wherein the controlling of the temperature of the heater may include, based on the time of recent use being within a certain time period, controlling the temperature of the heater based on a second dedicated temperature profile that is different from the dedicated temperature profile.

The dedicated temperature profile may be a temperature profile calculated by adjusting a basic temperature profile for a regular cigarette.

An embodiment of the present disclosure provides a computer-readable recording medium storing a program for executing the method.

### Advantageous Effects of Invention

According to the present disclosure, even if a wet cigarette is mounted in an aerosol-generating device, an aerosol may be stably provided to a user.

In addition, according to the present disclosure, even though a wet cigarette is mounted in an aerosol-generating device, the aerosol is not overheated, and thus a user may smoke safely.

In addition, according to the present disclosure, when a cigarette that is so humid as to cause malfunction of an aerosol-generating device is mounted in the aerosol-generating device, the heating of a heater of the aerosol-generating device is stopped, thereby preventing fatal damage to the aerosol-generating device and protecting a user from accidents.

In addition, according to the present disclosure, even if a wet cigarette is mounted in an aerosol-generating device that is being continuously used, a uniform and stable smoking satisfaction may be provided to the user.

### BRIEF DESCRIPTION OF DRAWINGS

FIGS. 1 and 2 are views illustrating examples in which a cigarette is inserted into an aerosol-generating device.

FIG. 3 is a view illustrating another example in which a cigarette is inserted into an aerosol-generating device.

FIG. 4 is a view illustrating an example of a cigarette.

FIG. 5 is a view illustrating another example of a cigarette.

FIG. 6 is a view illustrating an example of a double medium cigarette used in the aerosol-generating device of FIG. 3.

FIG. 7 is a perspective view of an example of an aerosol-generating device according to an embodiment of the present disclosure.

FIG. 8 is a side view of the aerosol-generating device of FIG. 7.

FIG. 9 is a graph showing a temperature change of a cigarette or a heater.

FIG. 10 is a flowchart of a method of controlling a heater temperature, according to an embodiment of the present disclosure.

FIG. 11 is a flowchart of a method of controlling a heater temperature, according to another embodiment of the present disclosure.

FIG. 12 is a flowchart of a method of controlling a heater temperature, according to another embodiment of the present disclosure.

FIG. 13 is an example of a perspective view of an aerosol-generating device including a capacitor for determining whether a wet cigarette is mounted in the aerosol-generating device.

FIG. 14 is a block diagram illustrating modules constituting a controller.

### MODE FOR THE INVENTION

With respect to the terms used to describe in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

Hereinafter, embodiments of the present disclosure will be described in detail with reference to the drawings.

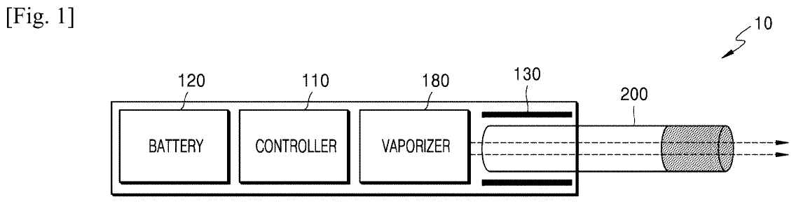

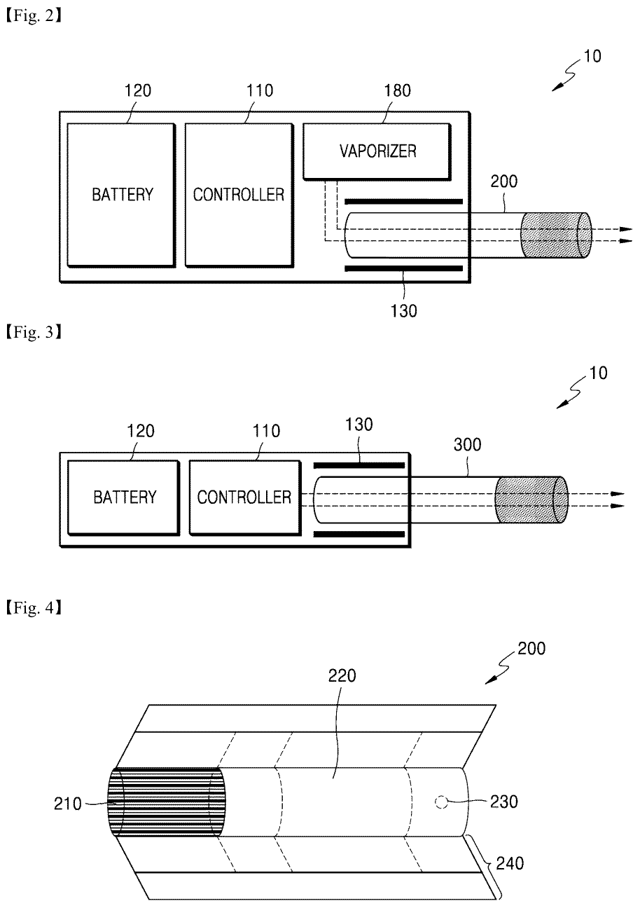

FIGS. 1 and 2 are diagrams showing examples in which an aerosol-generating article is inserted into an aerosol-generating device.

Referring to FIGS. 1 and 2, the aerosol-generating device 10 may include a battery 120, a controller 110, a heater 130, and a vaporizer 180. Also, the cigarette 200 may be inserted into an inner space of the aerosol-generating device 10.

FIGS. 1 and 2 only show certain components of the aerosol-generating device 10 which are related to the embodiments. Accordingly, it will be understood by one of ordinary skill in the art that other general-purpose components other than those shown in FIGS. 1 and 2 may be further included in the aerosol-generating device 10.

Also, FIGS. 1 and 2 illustrate that the aerosol-generating device 10 includes the heater 130. However, as necessary, the heater 130 may be omitted.

FIG. 1 illustrates that the battery 120, the controller 110, the vaporizer 180, and the heater 130 are arranged in series. Also, FIG. 2 illustrates that the vaporizer 180 and the heater 130 are arranged in parallel. However, the internal structure of the aerosol-generating device 10 is not limited to the structures illustrated in FIG. 1 or 2. In other words, according to the design of the aerosol-generating device 10, the battery 120, the controller 110, the vaporizer 180, and the heater 130 may be differently arranged.

When the cigarette 200 is inserted into the aerosol-generating device 10, the aerosol-generating device 10 may operate the vaporizer 180 to generate aerosol from the vaporizer 140. The aerosol generated by the vaporizer 180 is delivered to a user by passing through the cigarette 200. The vaporizer 180 will be described in more detail later.

The battery 120 may supply power to be used for the aerosol-generating device 10 to operate. For example, the battery 120 may supply power to heat the heater 130 or the vaporizer 140, and may supply power for operating the controller 110. Also, the battery 120 may supply power for operations of a display, a sensor, a motor, etc. mounted in the aerosol-generating device 10.

The controller 110 may generally control operations of the aerosol-generating device 10. In detail, the controller 110 may control not only operations of the battery 110, the heater 130, and the vaporizer 140, but also operations of other components included in the aerosol-generating device 10. Also, the controller 110 may check a state of each of the components of the aerosol-generating device 10 to determine whether or not the aerosol-generating device 10 is able to operate.

The controller 110 may include at least one processor. A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The heater 130 may be heated by the power supplied from the battery 110. For example, when the cigarette 200 is inserted into the aerosol-generating device 10, the heater 130 may be located outside the cigarette 200. Thus, the heated heater 130 may increase a temperature of an aerosol-generating material in the cigarette 200.

The heater 130 may include an electro-resistive heater. For example, the heater 130 may include an electrically conductive track, and the heater 130 may be heated when currents flow through the electrically conductive track. However, the heater 130 is not limited to the example described above and may include any other heaters which may be heated to a desired temperature. Here, the desired temperature may be pre-set in the aerosol-generating device 10 or may be set by a user.

As another example, the heater 130 may include an induction heater. In detail, the heater 130 may include an electrically conductive coil for heating an aerosol-generating article in an induction heating method, and the aerosol-generating article may include a susceptor which may be heated by the induction heater.

FIGS. 1 and 2 illustrate that the heater 130 is positioned outside the cigarette 200, but the position of the heater 130 is not limited thereto. For example, the heater 130 may include a tube-type heating element, a plate-type heating element, a needle-type heating element, or a rod-type heating element, and may heat the inside or the outside of the cigarette 200, according to the shape of the heating element.

Also, the aerosol-generating device 10 may include a plurality of heaters 130. Here, the plurality of heaters 130 may be inserted into the cigarette 200 or may be arranged outside the cigarette 200. Also, some of the plurality of heaters 130 may be inserted into the cigarette 200 and the others may be arranged outside the cigarette 200. In addition, the shape of the heater 130 is not limited to the shapes illustrated in FIGS. 1 and 2 and may include various shapes.

The vaporizer 180 may generate aerosol by heating a liquid composition and the generated aerosol may pass through the cigarette 200 to be delivered to a user. In other words, the aerosol generated via the vaporizer 180 may move along an air flow passage of the aerosol-generating device 10 and the air flow passage may be configured such that the aerosol generated via the vaporizer 180 passes through the cigarette 200 to be delivered to the user.

For example, the vaporizer 180 may include a liquid storage, a liquid delivery element, and a heating element, but it is not limited thereto. For example, the liquid storage, the liquid delivery element, and the heating element may be included in the aerosol-generating device 10 as independent modules.

The liquid storage may store a liquid composition. For example, the liquid composition may be a liquid including a tobacco-containing material having a volatile tobacco flavor component, or a liquid including a non-tobacco material. The liquid storage may be formed to be detachable from the vaporizer 180 or may be formed integrally with the vaporizer 140.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the liquid composition in contact with the heating element, thereby heating the liquid composition. As a result, aerosol may be generated.

For example, the vaporizer 180 may be referred to as a cartomizer or an atomizer, but it is not limited thereto.

The aerosol-generating device 10 may further include general-purpose components in addition to the battery 110, the controller 110, the heater 130, and the vaporizer 140. For example, the aerosol-generating device 10 may include a display capable of outputting visual information and/or a motor for outputting haptic information. Also, the aerosol-generating device 10 may include at least one sensor (a puff sensor, a temperature sensor, an aerosol generating article insertion detecting sensor, etc.). Also, the aerosol-generating device 10 may be formed as a structure that, even when the cigarette 200 is inserted into the aerosol-generating device 10, may introduce external air or discharge internal air.

Although not illustrated in FIGS. 1 and 2, the aerosol-generating device 10 and an additional cradle may form together a system. For example, the cradle may be used to charge the battery 120 of the aerosol-generating device 10. Alternatively, the heater 130 may be heated when the cradle and the aerosol-generating device 10 are coupled to each other.

The cigarette 200 may be similar to a general combustive cigarette. For example, the cigarette 200 may be divided into a first portion including an aerosol-generating material and a second portion including a filter, etc. Alternatively, the second portion of the cigarette 200 may also include an aerosol-generating material. For example, an aerosol-generating material made in the form of granules or capsules may be inserted into the second portion.

The first portion may be completely inserted into the aerosol-generating device 10, and the second portion may be exposed to the outside. Alternatively, only a portion of the first portion may be inserted into the aerosol-generating device 10, or a portion of the first portion and a portion of the second portion may be inserted thereinto. The user may puff aerosol while holding the second portion by the mouth of the user. In this case, the aerosol is generated by the external air passing through the first portion, and the generated aerosol passes through the second portion and is delivered to the user's mouth.

For example, the external air may flow into at least one air passage formed in the aerosol-generating device 10. For example, opening and closing of the air passage and/or a size of the air passage formed in the aerosol-generating device 10 may be adjusted by the user. Accordingly, the amount and the quality of smoking may be adjusted by the user. As another example, the external air may flow into the cigarette 200 through at least one hole formed in a surface of the cigarette 200.

FIG. 3 is a view illustrating another example in which a cigarette is inserted into an aerosol-generating device 10.

When compared with the aerosol-generating device 10 shown in FIGS. 1 and 2, the aerosol-generating device 10 shown in FIG. 3 does not include the vaporizer 180. Because an element performing the function of the vaporizer 180 is included in a double medium cigarette 300 inserted into the aerosol-generating device 10 shown in FIG. 3, the aerosol-generating device 10 according to FIG. 3 does not include the vaporizer 180, unlike the aerosol-generating device 10 shown in FIGS. 1 and 2.

When the double medium cigarette 300 is inserted into the aerosol-generating device 10 shown in FIG. 3, the aerosol-generating device 10 may generate an aerosol, which may be inhaled by a user, from the double medium cigarette 300 by externally heating the double medium cigarette 300. In addition, the double medium cigarette 300 will be described in detail below with reference to FIG. 6.

Hereinafter, an example of the cigarette 200 will be described with reference to FIG. 4.

FIG. 4 is a view illustrating an example of the cigarette.

Referring to FIG. 4, the cigarette 200 may include a tobacco rod 210 and a filter rod 220. The first portion described above with reference to FIGS. 1 and 2 may include the tobacco rod 210, and the second portion may include the filter rod 220.

FIG. 4 illustrates that the filter rod 220 includes a single segment, but embodiments are not limited thereto. In other words, the filter rod 220 may include a plurality of segments. For example, the filter rod 220 may include a first segment configured to cool an aerosol and a second segment configured to filter a certain component included in the aerosol. Also, as necessary, the filter rod 220 may further include at least one segment configured to perform other functions.

The cigarette 200 may be packaged by at least one wrapper 240. The wrapper 240 may have at least one hole through which external air may be introduced or internal air may be discharged. For example, the cigarette 200 may be packaged by one wrapper 240. As another example, the cigarette 200 may be double-packaged by two or more wrappers 240. For example, the tobacco rod 210 may be packaged by a first wrapper, and the filter rod 220 may be packaged by wrappers. Also, the entire cigarette 200 may be re-packaged by another single wrapper. When the filter rod 220 includes a plurality of segments, each segment may be packaged by an individual wrapper, and the entire cigarette 200 in which segments are wrapped by individual wrappers may be repackaged by another wrapper.

The tobacco rod 210 may include an aerosol-generating material. For example, the aerosol-generating material may include at least one of glycerin, propylene glycol, ethylene glycol, dipropylene glycol, diethylene glycol, tricthylene glycol, tetraethylene glycol, and oleyl alcohol, but it is not limited thereto. Also, the tobacco rod 210 may include other additives, such as flavors, a wetting agent, and/or organic acid. Also, the tobacco rod 210 may include a flavored liquid, such as menthol or a moisturizer, which is injected to the tobacco rod 210.

The tobacco rod 210 may be manufactured in various forms. For example, the tobacco rod 210 may be formed as a sheet or a strand. Also, the tobacco rod 210 may be formed as a pipe tobacco, which is formed of tiny bits cut from a tobacco sheet. Also, the tobacco rod 210 may be surrounded by a heat conductive material. For example, the heat conductive material may be, but is not limited to, a metal foil such as aluminum foil. For example, the heat conductive material surrounding the tobacco rod 210 may uniformly distribute heat transmitted to the tobacco rod 210, and thus, the heat conductivity applied to the tobacco rod may be increased and taste of the tobacco may be improved. Also, the heat conductive material surrounding the tobacco rod 210 may function as a susceptor heated by the induction heater. Here, although not illustrated in the drawings, the tobacco rod 210 may further include an additional susceptor, in addition to the heat conductive material surrounding the tobacco rod 210.

The filter rod 220 may include a cellulose acetate filter. Shapes of the filter rod 220 are not limited. For example, the filter rod 220 may include a cylinder-type rod or a tube-type rod having a hollow inside. Also, the filter rod 220 may include a recess-type rod. When the filter rod 220 includes a plurality of segments, at least one of the plurality of segments may have a different shape.

The filter rod 220 may be formed to generate flavors. For example, a flavoring liquid may be injected onto the filter rod 220, or an additional fiber coated with a flavoring liquid may be inserted into the filter rod 220.

Also, the filter rod 220 may include at least one capsule 230. Here, the capsule 230 may generate a flavor or an aerosol. For example, the capsule 230 may have a configuration in which a liquid containing a flavoring material is wrapped with a film. For example, the capsule 230 may have a spherical or cylindrical shape, but is not limited thereto.

When the filter rod 220 includes a segment configured to cool the aerosol, the cooling segment may include a polymer material or a biodegradable polymer material. For example, the cooling segment may include pure polylactic acid alone, but the material for forming the cooling segment is not limited thereto. In some embodiments, the cooling segment may include a cellulose acetate filter having a plurality of holes. However, the cooling segment is not limited to the above-described example and is not limited as long as the cooling segment cools the aerosol.

Although not shown in FIG. 4, the cigarette 200 according to an embodiment may further include a front-end filter. The front-end filter may be located on one side of the tobacco rod 210 which is opposite to the other side abutting the filter rod 220. The front-end filter may prevent the tobacco rod 210 from falling off and prevent the liquefied aerosol from flowing from the tobacco rod 210 into the aerosol-generating device (100 of FIGS. 1 and 3), during smoking.

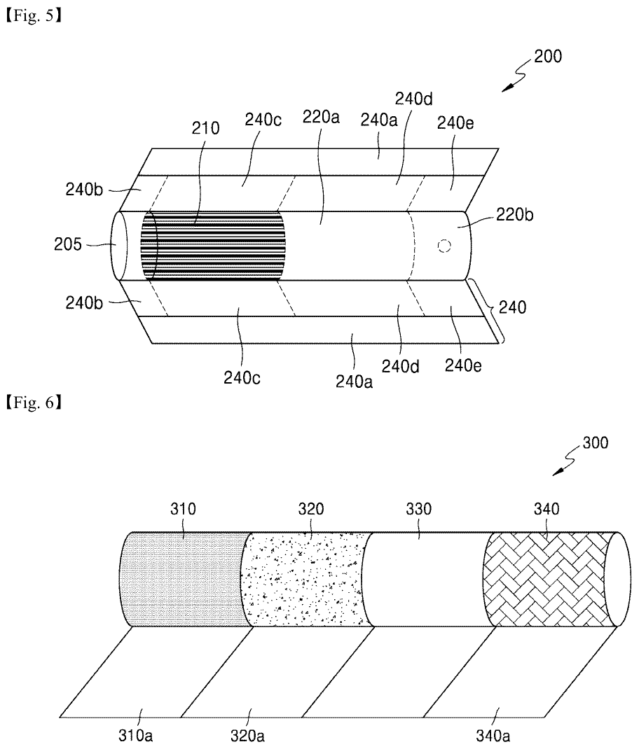

FIG. 5 is a view illustrating another example of the cigarette 200.

Referring to FIG. 5, the cigarette 200 may have a structure in which a cross tube 205, a tobacco rod 210, a tube 220a, and a filter 220b are wrapped by a plurality of wrappers 240, including the final wrapper 240a. In FIG. 5, the plurality of wrappers 240 include individual wrappers 240b, 240c, 240d, and 240e respectively surrounding the cross tube 205, the tobacco rod 210, the tube 220a, and the filter 220b. The final wrapper 240a may be wrapped around the cross tube 205, the tobacco rod 210, the tube 220a, and the filter 220b respectively surrounded by the individual wrappers 240b, 240c, 240d, and 240c.

The first part described above with reference to FIGS. 1 and 2 includes the cross tube 205 and the tobacco rod 210, and the second part includes the filter rod 220. For convenience of description, the following description will be made with reference to FIGS. 1 and 2, and descriptions the same as those given with reference to FIG. 4 will be omitted.

The cross tube 205 refers to a tube in the form of a cross, which is connected to the tobacco rod 210.

When the cigarette 200 is inserted into an aerosol-generating device, the cross tube 205 and the tobacco rod 210 may be sensed by a cigarette detection sensor. The cross tube 205 may be wrapped with a copper laminating paper wrapper which also wraps the tobacco rod 210, and may be used for the cigarette detection sensor to determine whether the cigarette 200 inserted is compatible with the aerosol-generating device (e.g., whether the cigarette and the aerosol-generating device are manufactured by the same company).

The tobacco rod 210 includes an aerosol-generating material that is heated by the heater 130 of the aerosol-generating device 10 and generates an aerosol.

The tube 220a performs a function of transferring, to the filter 220b, an aerosol generated from the aerosol-generating material of the tobacco rod 210. The tube 220a be manufactured by adding triacetin (TA), i.e., a plasticizer, to cellulose acetate tow and molding the triacetin (TA) into a circle. When compared with the cross tube 205, the tube 220a has a different shape and arranged differently in that the tube 220a connects the tobacco rod 210 and the filter 220b.

When an aerosol generated by the tobacco rod 210 is delivered to the filter 220b through the tube 220a, the filter 220b passes the aerosol to allow a user to inhale the aerosol filtered by the filter 220b. The filter 220b may be a cellulose acetate filter manufactured based on cellulose acetate tow.

The final wrapper 240a is a paper surrounding each of the cross tube 205, the tobacco rod 210, the tube 220a, and the filter 220b, and may include a cross tube wrapper 240b, a tobacco rod wrapper 240c, a tube wrapper 240d, and a filter wrapper 240c.

In FIG. 5, for example, the cross tube wrapper 240b may include an aluminum material. The tube wrapper 240d surrounding the tube 220a may be a MFW or 24K wrapper, and the filter wrapper 240e surrounding the filter 220b may be an oil-resistant hard wrapper or a laminating paper having a poly lactic acid (PLA) material. The tobacco rod wrapper 240c and the final wrapper 240a will be described in more detail below.

The tobacco rod wrapper 240c surrounds the tobacco rod 210, and may be coated with a thermal conductivity improving material in order to maximize the efficiency of thermal energy transfer from the heater 130. For example, the tobacco rod wrapper 240c may be manufactured in a way that a general wrapper or a release base paper is coated with at least one of silver (Ag) foil paper, aluminum (Al) foil paper, copper (Cu) foil paper, carbon paper, filler, ceramic (e.g., AlN or Al₂O₃), silicon carbide, sodium citrate (e.g., Na citrate), potassium citrate (e.g., K citrate), aramid fiber, nano cellulose, mineral paper, glassine paper, and single-walled carbon nanotube (SWNT). The general wrapper refers to a wrapper widely used in cigarettes in the market, and may be a porous wrapper made of a material that has been tested for hand-made paper and has at least a certain level of paper manufacturing workability and thermal conductivity.

In addition, in an embodiment of the present disclosure, the final wrapper 240a may be manufactured in such a way that MFW base paper is coated with at least one of filler, ceramic, silicon carbide, sodium citrate, potassium citrate, aramid fiber, nano cellulose, and SWNT, among various materials used for coating the tobacco rod wrapper 240c.

The heater 130 included in the externally heating-type aerosol-generating device 10 described with reference to FIGS. 1 and 2 is controlled by the controller 110 and heats the aerosol-generating material included in the tobacco rod 210 to generate an aerosol. In this case, thermal energy transferred to the tobacco rod 210 may be composed of 75% radiant heat, 15% convective heat, and 10% conduction heat. Depending on embodiments, the proportions of radiant heat, convective heat, and conduction heat constituting the thermal energy transferred to the tobacco rod 210 may vary.

In a case where the heater 130 does not directly contact the aerosol-generating material, it may be difficult to rapidly generate an aerosol. In this regard, according to an embodiment, a thermal conductivity improving material may be used for coating the tobacco rod wrapper 240c and the final wrapper 240a such that thermal energy may be efficiently transferred to the aerosol-generating material of the tobacco rod 210. Accordingly, a sufficient amount of aerosol may be provided to a user even during an initial puff before the heater 130 is sufficiently heated.

According to an embodiment, the thermal conductivity improving material may be used for coating only one of the tobacco rod wrapper 240c and the final wrapper 240a. Also, a material having at least a certain level of thermal conductivity, such as organic metal, inorganic metal, fiber, or polymeric material, may be used for coating the tobacco rod wrapper 240c or the final wrapper 240a.

FIG. 6 is a view illustrating an example of the double medium cigarette 300 used in the aerosol-generating device 10 of FIG. 3.

The name of the double medium cigarette in FIG. 6 is not only for the purpose of distinguishing the double medium cigarette from the cigarettes shown in FIGS. 4 and 5, but also to simplify the description of the present disclosure.

Referring to FIG. 6, the double medium cigarette 300 may have a structure in which an aerosol base portion 310, a medium portion 320, a cooling portion 330, and a filter portion 340 are sequentially arranged and wrapped by a final wrapper 350. In FIG. 6, the final wrapper 350 refers to an outer shell that surrounds individual wrappers 310a, 320a, and 340a which respectively surround the aerosol base portion 310, the medium portion 320, and the filter portion 340.

The aerosol base portion 310 may be made of pulp-based paper to which a moisturizing agent is added. The moisturizing agent (i.e., a basic material) contained in the aerosol base portion 310 may include propylene glycol and glycerin, which have a certain weight ratio with respect to the weight of a base paper. When the double medium cigarette 300 is inserted into the aerosol-generating device 10 of FIG. 3, the aerosol base portion 310 may generate moisturizing agent vapor when heated to or above a certain temperature.

The medium portion 320 includes at least one of a sheet, a strand, and pipe tobacco obtained by cutting a tobacco sheet into small pieces, and generates nicotine to provide a smoking experience to a user. The medium portion 320 may not be directly heated from the heater 130 even though the double medium cigarette 300 is inserted into the aerosol-generating device 10 of FIG. 3. Instead, the medium portion 320 may be indirectly heated by conduction, convection and radiation through the aerosol base portion 310 and a medium portion wrapper 320a (or a final wrapper 350) surrounding the medium portion 320, when they are heated. Specifically, the medium contained in the medium portion 320 needs to be heated to a lower temperature than the moisturizing agents contained in the aerosol base portion 310. In this regard, according to an embodiment, the medium portion 320 may be indirectly heated by the aerosol base portion 310 rather than by the heater 130 that is an external heating type heater. When the temperature of a medium included in the medium portion 320 rises to a temperature above a certain level, nicotine vapor is generated from the medium portion 320.

According to an embodiment, when the double medium cigarette 300 is inserted into the aerosol-generating device 10 of FIG. 3, a portion of the medium portion 320 may be positioned to face the heater 130 and thus may be directly heated by the heater 130.

The cooling portion 330 may be made of a tube filter containing a plasticizer having a certain weight. The moisturizing agent vapor and the nicotine vapor respectively generated from the aerosol base portion 310 and the medium portion 320 may be mixed and aerosolized, and then may be cooled while passing through the cooling portion 330. The cooling portion 330 may not be wrapped with an individual wrapper, unlike the aerosol base portion 310, the medium portion 320, or the filter portion 340.

The filter portion 340 may be a cellulose acetate filter, and the shape of the filter portion 340 is not limited. The filter portion 340 may be a cylinder-type type rod or a tube-type rod including a hollow therein. When the filter portion 340 is composed of a plurality of segments, at least one of the plurality of segments may be manufactured to have a different shape. The filter portion 340 may be manufactured to generate flavor. As an example, a flavoring liquid may be injected into the filter portion 340, and a separate fiber to which a flavoring liquid is applied may be inserted into the filter portion 340.

In addition, at least one capsule may be included in the filter portion 340. In this case, the capsule may perform a function of generating flavor. For example, the capsule may have a structure in which a liquid containing a fragrance is wrapped with a film, and may have a spherical or cylindrical shape. However, embodiments are not limited thereto.

The final wrapper may refer to an outer shell that surrounds the aerosol base portion 310, the medium portion 320, and the filter portion 340, which are respectively surrounded by individual wrappers. The final wrapper 350 may include the same material as the medium portion wrapper to be described below.

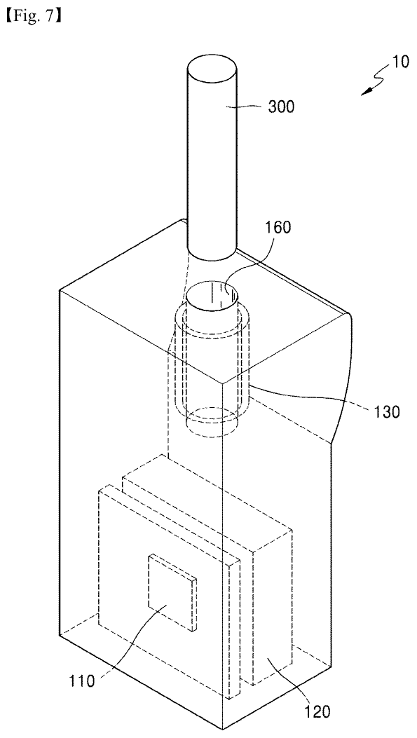

FIG. 7 is a perspective view of an example of an aerosol-generating device 10 according to an embodiment of the present disclosure.

Referring to FIG. 7, the aerosol-generating device 10 according to an embodiment of the present disclosure may include a controller 110, a battery 120, and a heater 130. The double medium cigarette 300 may be inserted into and heated by the aerosol-generating device 10 to generate an aerosol. For convenience of description, only some components of the aerosol-generating device 10 are highlighted and shown in FIG. 7. Thus, the aerosol-generating device 10 may include additional components without departing from the scope of the present disclosure.

In addition, the internal structure of the aerosol-generating device 10 is not limited to that shown in FIG. 7, and according to embodiments or designs, the arrangements of the controller 110, the battery 120, the heater 130, and the double medium cigarette 300 may vary. A description of each component of FIG. 7 will be omitted because it has already been described with reference to FIGS. 1 to 3.

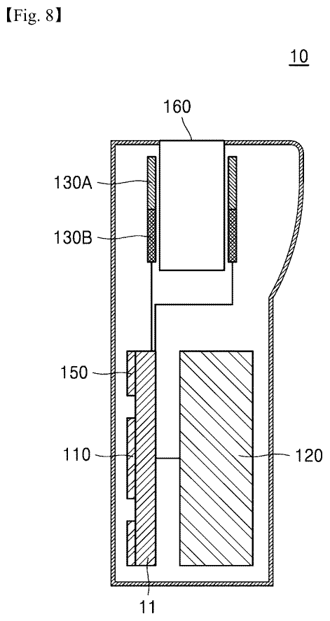

FIG. 8 is a side view of the aerosol-generating device 10 of FIG. 7.

Referring to FIG. 8, the aerosol-generating device 10 according to an embodiment of the present disclosure may include a printed circuit board (PCB) 11, a controller 110, a battery 120, a first heater 130A, a second heater 130B, a display 150, and a cigarette insertion space 160. Hereinafter, the same description provided above with reference to FIG. 1 will be omitted.

The PCB 11 may perform a function of electronically integrating various components that collect information of the aerosol-generating device 10 while communicating with the controller 110. The controller 110 and the display 150 may be fixedly mounted on the surface of the PCB 11, and the battery 120 for supplying power to devices connected to the PCB 11 may be connected to the surface of the PCB 11.

The first heater 130A and the second heater 130B respectively heat two medium portions of the double medium cigarette 300 to different temperatures, while the double medium cigarette 300 is inserted into the cigarette insertion space 160 of the aerosol-generating device of FIG. 8. The first heater 130A and the second heater 130B may be heated to different temperatures by including different materials, or by receiving different control signals from the controller 110 while including the same material.

The display 150 is a device for outputting visual information to a user, from among information generated by the aerosol-generating device 10. The display 150 may control, based on information received from the controller 110, information output to a display panel (e.g., liquid crystal display (LCD) panel or a light-emitting diode (LED) panel) provided on the front of the aerosol-generating device 10.

The cigarette insertion space 160 refers to a space for receiving the cigarette 200 or the double medium cigarette 300. The cigarette insertion space 160 may have a cylindrical shape so that the cigarette 200 or the double medium cigarette 300, which has the form of a stick, is stably mounted therein, and the height (depth) of the cigarette insertion space 160 may vary depending on the length of a region including an aerosol-generating material in the cigarette 200 or the double medium cigarette 300.

For example, when the double medium cigarette 300 described with reference to FIG. 6 is inserted into the cigarette insertion space 160, the height of the cigarette insertion space 160 may be equal to the sum of the length of the aerosol base portion 310 and the length of the medium portion 320. When the cigarette 200 or the double medium cigarette 300 is inserted into the cigarette insertion space 160, the first heater 130A and the second heater 130B, which are adjacent to the cigarette insertion space 160, may be heated, and thus, aerosols may be generated.

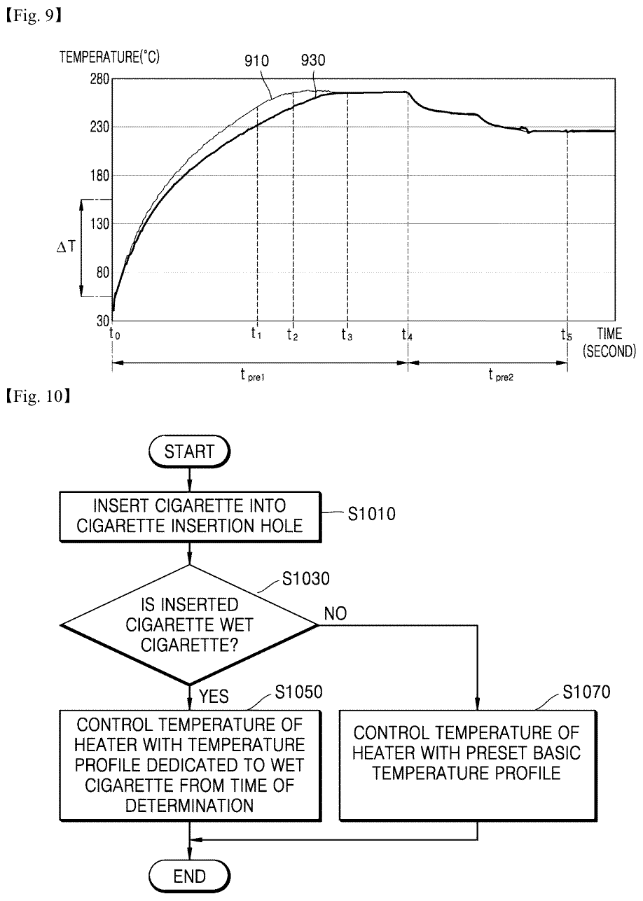

FIG. 9 is a graph showing a temperature change of a cigarette or a heater.

More specifically, FIG. 9 are graphs showing a change in a temperature of a heater when a regular cigarette and a wet cigarette are mounted in the aerosol-generating device according to an embodiment of the present disclosure. It may be seen that a graph 910 for the regular cigarette and a graph 930 for the wet cigarette are different from each other.

In the graph of FIG. 9, the horizontal axis (i.e., x-axis) denotes a time for which power is supplied to the heater and the heater is heated. In addition, the vertical axis (y-axis) denotes the temperature (hereinafter, referred to as a “substrate temperature”) of an aerosol-generating material inside a cigarette which is heated in contact with the heater. Also, according to an embodiment, the vertical axis (i.e., y-axis) may be interpreted as denoting the temperature of the heater.

First, after a regular cigarette is inserted through a cigarette insertion hole of the aerosol-generating device at room temperature (i.e., 25 degrees Celsius), the temperature of the heater rises from room temperature to the maximum temperature over time. For example, when a regular cigarette is mounted in the aerosol-generating device, the maximum temperature of the heater may be 270 degrees Celsius. After the regular cigarette is mounted in the aerosol-generating device, the temperature of the heater reaches the maximum temperature at time t2.

The temperature of the heater that has reached the maximum temperature is maintained until time t4. In FIG. 9, a period from a time when the heater starts to be heated in the aerosol-generating device to a time until which the maximum temperature is maintained may be referred to as a first preheating time period tₚᵣₑ₁. The temperature of the heater, which has reached the maximum temperature during the first preheating time period tₚᵣₑ₁, is lowered to a preset temperature during a second preheating time period tₚᵣₑ₂. From time t₅, the temperature is stably maintained through feedback control such as Proportional-Integral-Differential (PID) control, such that a sufficient amount of aerosol may be continuously generated in the aerosol-generating device.

The aerosol-generating device according to an embodiment of the present disclosure may stably provide an aerosol to a user even if a wet cigarette is mounted in the aerosol-generating device.

Referring to FIG. 9, it may be seen that, when a wet cigarette is mounted in the aerosol-generating device, a heating rate is slower than a heating rate in a case where a regular cigarette is mounted in the aerosol-generating device. As described above, in FIG. 9, when a regular cigarette is mounted in the aerosol-generating device and the heater is heated, the temperature of the heater reaches the maximum temperature at time t₂. On the other hand, when a wet cigarette is mounted in the aerosol-generating device and the heater is heated, the temperature of the heater reaches the maximum temperature at time t₃, which is later than time t₂.

The graph 930 for a wet cigarette in FIG. 9 is an example of a result obtained by applying a control logic or controller according to an embodiment of the present disclosure to the aerosol-generating device. In the aerosol-generating device according to an embodiment of the present disclosure, when a wet cigarette is mounted in the aerosol-generating device, the controller may use a dedicated temperature profile, which is used to generate an aerosol by stably heating a wet cigarette, instead of a temperature profile that is used when a regular cigarette is mounted in the aerosol-generating device.

If a temperature profile for heating a regular cigarette is applied when a wet cigarette is mounted in the aerosol-generating device, an algorithm for maintaining the temperature of the heater at time t₂ is operated. In this case, because the heating rate of the heater is slower when a wet cigarette is mounted in the aerosol-generating device than in the case of a regular cigarette, the algorithm maintains the temperature of the heater at time t₂, which is lower than 270 degrees Celsius. Accordingly, the temperature of the heater will not reach the maximum temperature during the first preheating time period tₚᵣₑ₁.

Therefore, since the wet cigarette does not receive sufficient heat energy from the heater does not reach the maximum temperature, the wet cigarette generates an incomplete aerosol, which may not provide a satisfactory feeling of smoking to the user. and thus a satisfactory feeling of smoking may not be provided to the user. Besides, since the incomplete aerosol containing the hot moisture of the wet cigarette itself the aerosol may be much hotter than an aerosol generated through normal processes, it may cause physical damage to the user.

As shown in FIG. 9, the aerosol-generating device according to an embodiment of the present disclosure may appropriately control the temperature of the heater with a dedicated temperature profile from a point in time when the controller determines that a wet cigarette is mounted in the aerosol-generating device, thereby stably generating an aerosol even though the wet cigarette is mounted in the aerosol-generating device. In particular, when it is determined that a mounted cigarette is a wet cigarette, the controller of the aerosol-generating device according to an embodiment of the present disclosure applies a dedicated temperature profile that reflects the delay in the temperature of the heater reaching the highest point, and thus an aerosol may be stably generated from the wet cigarette.

As an embodiment, time t₁ in FIG. 9 may be a point in time when the controller determines that a cigarette inserted through the cigarette insertion hole is a wet cigarette. The controller may determine whether a mounted cigarette is a wet cigarette even while the heater is being heated, not when the heater starts to be heated. Time t₁ may precede time t2 when the temperature of the heater reaches the maximum temperature in the graph 910 for the regular cigarette.

The controller may determine whether a cigarette mounted in the aerosol-generating device is a wet cigarette through various methods at time t1. For example, the controller may determine whether a cigarette mounted in the aerosol-generating device is a wet cigarette based on a temperature increase rate when a first time has elapsed since the heater started to be heated. In this case, the temperature increase rate means the rate of temperature increase of the heater per unit time (e.g., a second), and the first time may be t1 in FIG. 9. The temperature increase rate may also be referred to as the heating rate of the heater in the aspect of physical analysis.

The controller measures the slope of the graph (i.e., the temperature increase rate) between time 10 (i.e., the starting point on the x-axis when heating of the heater begins) and time t1, and determines whether a wet cigarette is mounted in the aerosol-generating device based on a result of comparing the value of the measured slope with a preset reference slope value. For example, the reference slope value may be the slope of the graph 910 for a regular cigarette between time t0 and time t1. As described above, because the temperature increase rate of the wet cigarette is slower than the temperature increase rate of the regular cigarette, the graph 930 for a wet cigarette has a smaller slope value than the graph 910 for a regular cigarette between time 10 and time t1. Alternatively, the preset reference slope value may be greater than the slope of the graph 930 for the wet cigarette between time to and time t1, and smaller than the slope of the graph 910 for the regular cigarette between time t0 and time t1.

As another embodiment, the controller may determine whether a wet cigarette is mounted in the aerosol-generating device based on the temperature of the heater when the first time has elapsed since the heater started to be heated. Since the temperature increase rate of the wet cigarette is slower than that of the regular cigarette, the controller may determine that a wet cigarette is inserted when the temperature of the heater at time t1 is lower than a preset reference temperature (e.g., the temperature of the heater in the graph 910 at time t1).

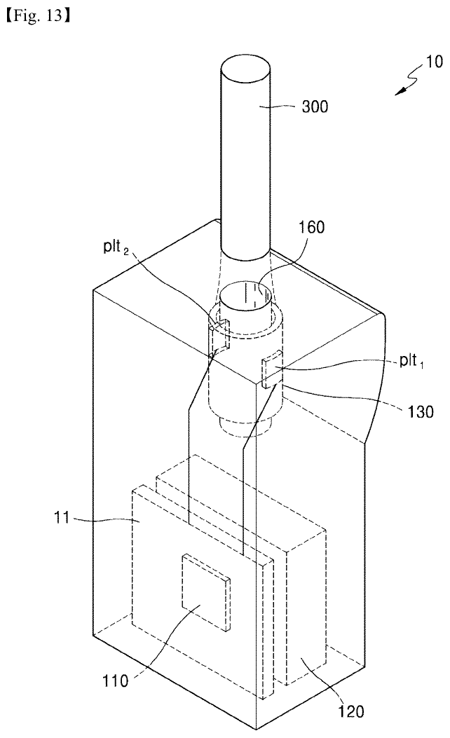

In the above two embodiments, the controller determines whether a wet cigarette is mounted in the aerosol-generating device by measuring the temperature increase rate or the temperature of the heater at a point in time when the first time has elapsed. That is, the controller may not determine whether the mounted cigarette is a wet cigarette until the heater is heated and the temperature rises. In this regard, in order to determine whether a wet cigarette is mounted in the aerosol-generating device before power is supplied to the heater, a capacitor may be disposed adjacent to the cigarette insertion hole and a detected change in capacitance of the capacitor may be used. This will be described later with reference to FIG. 13.

When a mounted cigarette is a wet cigarette, the controller may select one of a plurality of dedicated temperature profiles according to the amount of moisture contained in the wet cigarette to control the temperature of the heater. Because the rate of temperature rise of the aerosol-generating material varies depending on the moisture content in the wet cigarette, the controller may select one of a plurality of preset dedicated temperature profiles based on a detected amount of moisture.

In FIG. 9, ΔT represents the temperature range of the heater referred to by the controller to determine the continuous use of the aerosol-generating device. In FIG. 9, ΔT may be 100° C., and the maximum temperature value and minimum temperature value for calculating ΔT may be 150° C. and 50° C., respectively. The aerosol-generating device with sufficient battery capacity may be continuously used without charging the battery even after one smoking session composed of a plurality of puffs is ended. When the aerosol-generating device is continuously used, the heater is heated again even before being cooled down to room temperature. That is, when the heater starts to be heated, the initial temperature of the heater is much higher than the room temperature (e.g., 50° C. to 150° C.). As a result, the pattern of increasing the temperature of the heater and the temperature of the aerosol-generating material may be different from when the heater begins to be heated at room temperature. In particular, when the mounted cigarette is a wet cigarette, a dedicated temperature profile for stably generating an aerosol is required.

In the aerosol-generating device according to an embodiment of the present disclosure, when a wet cigarette is heated with the initial temperature of the heater that is much higher than room temperature due to continuous use of the aerosol-generating device, the temperature of the heater may be controlled based on a dedicated temperature profile corresponding to the situation. As an example, when the controller detects continuous use of the aerosol-generating device and determines that the mounted cigarette is a wet cigarette, the controller may apply a dedicated temperature profile which assumes that the temperature of the aerosol-generating material reaches the maximum temperature at an earlier time than time t; in FIG. 9. In this case, the temperature of the aerosol-generating material reaches the maximum temperature earlier than time t; as power is supplied to the heater while the temperature of the heater is higher than a normal initial level (e.g., room temperature) due to the continuous use of the aerosol-generating device.

Unlike the embodiment described above, the controller may detect when the aerosol-generating device was most recently used by a user. When the most recent use is within a certain reference time, the controller may determine continuous use of the aerosol-generating device. Based on a usage log stored in a memory of the aerosol-generating device, the controller may determine a continuous use operation without measuring the temperature of the heater.

As an embodiment different from the embodiments described above, the graph 930 for the wet cigarette in FIG. 9 may be a graph derived from the graph 910 for the regular cigarette. In FIG. 9, the graph 910 for the regular cigarette and the graph 930 for the wet cigarette are graphs obtained by plotting results according to a temperature profile corresponding to the regular cigarette and a dedicated temperature profile for the wet cigarette, respectively. In other words, the dedicated temperature profile for the wet cigarette may be calculated by adjusting a basic temperature profile of the regular cigarette.

In the graph 930 for the wet cigarette in FIG. 9, a point in time of reaching the maximum temperature is only slightly delayed when compared with the graph 910 for the regular cigarette. After time t3, the two graphs 930 and 910 coincide with each other. Therefore, when it is determined that the mounted cigarette is a wet cigarette, the controller may calculate a dedicated temperature profile by delaying, by a preset value, a point in time of reaching the maximum temperature in the basic temperature profile for a regular cigarette. In this case, the preset value may vary depending on the moisture content of the wet cigarette.

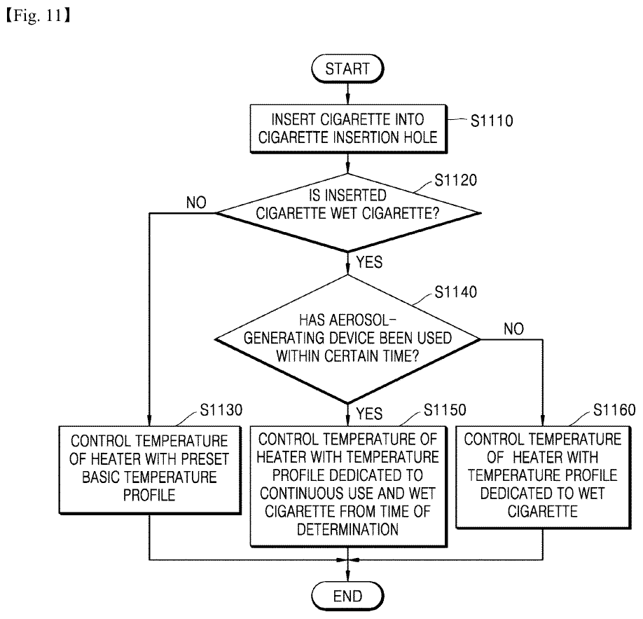

FIG. 10 is a flowchart of a method of controlling a heater temperature, according to an embodiment of the present disclosure.

The method shown in FIG. 10 may be performed by the controller of the aerosol-generating device.

When a cigarette is inserted into the cigarette insertion hole (operation S1010), the controller determines whether the inserted cigarette is a wet cigarette (operation S1030).

In operation S1030, the controller may determine whether the inserted cigarette is a wet cigarette in various ways.

For example, the controller may determine whether the inserted cigarette is a wet cigarette based on a temperature increase rate in a preset temperature range. A minimum temperature value defining the preset temperature range may be selected in a range of 50 degrees Celsius to 120 degrees Celsius. A maximum temperature value defining the preset temperature range may be selected in a range of 230 degrees Celsius to 320 degrees Celsius. The preset temperature range may be determined by the minimum temperature value and the maximum temperature value, and may be, for example, 70 degrees Celsius to 300 degrees Celsius.

The controller may measure the time taken for the temperature of the heater to rise from 70 degrees Celsius to 300 degrees Celsius, to determine the heating rate of the heater, and may detect a moisture content of a cigarette inserted into the cigarette insertion hole, based on the determined heating rate of the heater. When the time taken for the temperature of the heater to rise from 70 degrees Celsius to 300 degrees Celsius is longer than a preset time, the controller may determine that the inserted cigarette is a wet cigarette. When the time is shorter than the preset time, the controller may determine that the inserted cigarette is a regular cigarette.

As another example, the controller may determine whether the inserted cigarette is a wet cigarette, based on the temperature of the heater at a preset reference point in time. For example, the controller may measure the temperature of the heater when 20 seconds have elapsed since power is supplied to the heater, and when the measured temperature is equal to or less than a preset temperature, the controller may determine that the inserted cigarette is a wet cigarette. The reference point in time referenced by the controller may be selected in a range of 0 to 50 seconds.

When it is determined that the inserted cigarette is a wet cigarette, the controller may control the temperature of the heater with a temperature profile dedicated to the wet cigarette from the time of determination (operation S1050). When it is determined that the inserted cigarette is a regular cigarette rather than a wet cigarette, the controller may control the temperature of the heater with a preset basic temperature profile (operation S1070).

FIG. 11 is a flowchart of a method of controlling a heater temperature, according to another embodiment of the present disclosure.

When a cigarette is inserted into the cigarette insertion hole (operation S1110), the controller determines whether the inserted cigarette is a wet cigarette (operation S1120). If it is determined that the inserted cigarette is a regular cigarette, the controller may control the temperature of the heater with a preset basic temperature profile (operation S1130).

When it is determined that the inserted cigarette is a wet cigarette, the controller determines whether the aerosol-generating device has been used within a certain time (operation S1140). If it is determined that the aerosol-generating device has been used within the certain time, the controller may control the temperature of the heater with a temperature profile dedicated to continuous use and wet cigarette from the time of determination (operation S1150).

When it is determined that the inserted cigarette is a wet cigarette but the aerosol-generating device has not been used within the certain time, the controller may control the temperature of the heater with a temperature profile dedicated to the wet cigarette (operation S1160). As described above with reference to FIG. 9, the dedicated temperature profile of operation S1150 and the dedicated temperature profile of operation S1160 are different from each other.

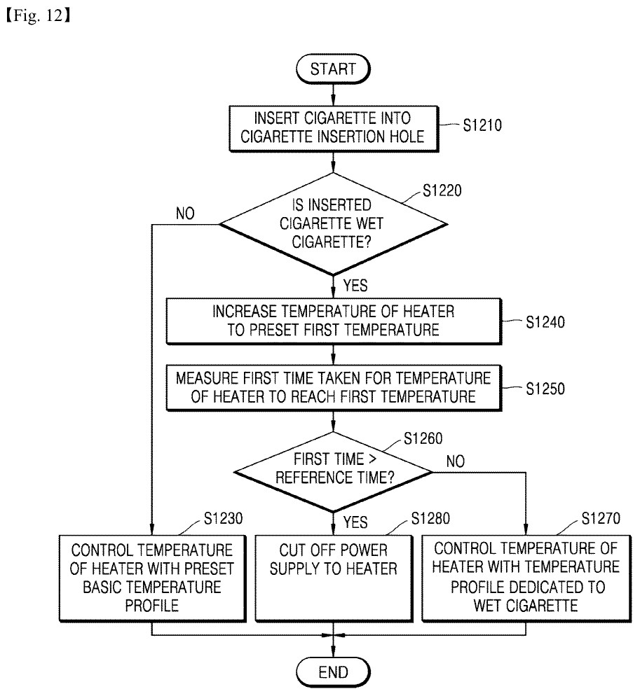

FIG. 12 is a flowchart of a method of controlling a heater temperature, according to another embodiment of the present disclosure.

Specifically, FIG. 12 is a flowchart showing a method for a case in which the aerosol may not be stably generated only by controlling the temperature of the heater with a dedicated temperature profile because the moisture content of a wet cigarette is excessive.

When a cigarette is inserted into the cigarette insertion hole (operation S1210), the controller determines whether the inserted cigarette is a wet cigarette (operation S1220). If it is determined that the inserted cigarette is a regular cigarette, the controller may control the temperature of the heater with a preset basic temperature profile (operation S1230).

When it is determined that the inserted cigarette is a wet cigarette, the controller may increase the temperature of the heater to a preset first temperature (operation S1240), and may measure a first time, which is a time taken for the temperature of the heater to reach the first temperature (operation S1250). According to an embodiment, the first time measured in operation S1250 may be the temperature of the aerosol-generating material rather than the temperature of the heater.

When the first time is not greater than a reference time, the controller may control the temperature of the heater with a temperature profile dedicated to the wet cigarette (operation S1270).

When the first time is greater than the reference time, the controller may determine that a delay in a temperature increase greater than a tolerable error has occurred, and may cut off the power supply to the heater (operation S1280). The occurrence of a delay in a temperature increase greater than a tolerable error in operation S1280 indicates that the moisture content of a cigarette is too high and thus an aerosol may not be generated by a normal heating method.

FIG. 13 is an example of a perspective view of an aerosol-generating device including a capacitor for determining whether a wet cigarette is mounted in the aerosol-generating device.

A first electrode plt₁ and a second electrode plt₂, which constitute the capacitor, are disposed on both sides of a cigarette insertion space 160. Accordingly, when a double medium cigarette 300 containing a material for generating an aerosol is fully seated in the cigarette insertion space 160 through a cigarette insertion hole, a change in the permittivity between the first electrode plt₁ and the second electrode plt₂ occurs. As a result, the capacitance of the capacitor is temporarily changed.

Because a wet cigarette contains more moisture than a regular cigarette and the relative permittivity of water has a relatively high value compared to other materials, a change in capacitance when a wet cigarette is mounted in the aerosol-generating device is more dramatic than a change in capacitance when a regular cigarette is mounted in the aerosol-generating device. Thus, the controller may accurately determine whether a wet cigarette is mounted in the aerosol-generating device based on such a change in capacitance.

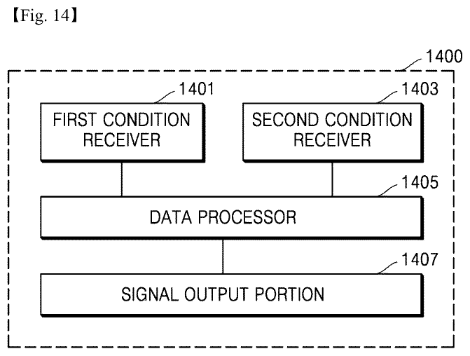

FIG. 14 is a block diagram illustrating modules constituting a controller 1400.

The controller 1400 that is included in the aerosol-generating device according to an embodiment of the present disclosure may include a plurality of modules physically or logically. Referring to FIG. 14, the controller 1400 may include a first condition receiver 1401, a second condition receiver 1403, a data processor 1405, and a signal output portion 1407.

The first condition receiver 1401 may receive information for determining a wet cigarette from a sensor such as a capacitor disposed adjacent to the cigarette insertion hole.

The second condition receiver 1403 may receive information for determining a continuous operation of the aerosol-generating device from various sensors. As an example, a memory included in the aerosol-generating device may store the recent operation completion time of the aerosol-generating device and transmit it to the second condition receiver 1403 so that the data processor 1405 may determine whether the aerosol-generating device is being continuously used within a preset time.

The data processor 1405 receives information from the first condition receiver 1401 and the second condition receiver 1403 and performs a function of integrally processing the received information. The data processor 1405 is a module in which substantially all processing is performed, and may be a microprocessor implemented as a single chip.

The signal output portion 1407 receives a processing result of the data processor 1405, generates a signal according to the result, and outputs the signal to various modules other than the controller 1400. For example, the proper control of the temperature of the heater may be according to a power control signal output from the signal output portion 1407 and transmitted to the heater.

The modules constituting the controller 1400 in FIG. 14 are named based on their functions to intuitively explain the present disclosure, and the types, functions, and number of modules included in the controller 1400 are variable according to embodiments.

According to the present disclosure, even if a wet cigarette is mounted in an aerosol-generating device, an aerosol may be stably provided to a user.

In addition, according to the present disclosure, even if a wet cigarette is mounted in an aerosol-generating device, the aerosol is prevented from being overly heated, and thus a user may smoke safely.

In addition, according to the present disclosure, when a cigarette that is so humid as to cause malfunction of an aerosol-generating device is mounted in the aerosol-generating device, the heating of a heater of the aerosol-generating device is stopped, thereby preventing fatal damage to the aerosol-generating device and protecting a user from accidents.

In addition, according to the present disclosure, even if a user continuously uses an aerosol-generating device with a wet cigarette, a uniform and stable smoking satisfaction may be provided to the user.

The embodiments of the present disclosure may be implemented in the form of a computer program which may be executed on a computer via various types of components, and such a computer program may be recorded on a computer-readable recording medium. The medium may include a magnetic medium such as a hard disk, a floppy disk, and a magnetic tape, an optical recording medium such as CD-ROM and DVD, a magneto-optical medium such as a floptical disk, and a hardware device specifically configured to store and execute program instructions, such as ROM, RAM, and flash memory.

The computer program is specifically designed and configured for the present disclosure but may be known to and used by one of ordinary skill in the computer software field. Examples of the computer program may include a high-level language code which may be executed using an interpreter or the like by a computer, as well as a machine language code such as that made by a complier.

The specific implementations described in the present disclosure are example embodiments and do not limit the scope of the present disclosure in any way. For brevity of the specification, descriptions of existing electronic configurations, control systems, software, and other functional aspects of the systems may be omitted. Connections of lines or connection members between components illustrated in the drawings illustratively show functional connections and/or physical or circuit connections and may be represented as alternative or additional various functional connections, physical connections, or circuit connections in an actual device. Unless specifically mentioned, such as “essential”, “importantly”, etc., the components may not be necessary components for application of the present disclosure.

As used herein (in particular, in claims), use of the term “the” and similar indication terms may correspond to both singular and plural. When a range is described in the present disclosure, the present disclosure may include the invention to which individual values belonging to the range are applied (unless contrary description), and each individual value constituting the range is the same as being described in the detailed description of the disclosure. Unless there is an explicit description of the order of the steps constituting the method according to the present disclosure or a contrary description, the steps may be performed in an appropriate order. The present disclosure is not necessarily limited to the description order of the steps. The use of all examples or example terms (for example, etc.) is merely for describing the present disclosure in detail, and the scope of the present disclosure is not limited by the examples or the example terms unless the examples or the example terms are limited by claims. It will be understood by one of ordinary skill in the art that various modifications, combinations, and changes may be made according to the design conditions and factors within the scope of the appended claims or equivalents thereof.

1. An aerosol-generating device comprising:
a heater configured to heat an aerosol-generating material of a cigarette; and
a controller configured to determine whether the cigarette inserted through a cigarette insertion hole is a wet cigarette, and control a temperature of the heater based on a dedicated temperature profile corresponding to the wet cigarette based on the inserted cigarette being the wet cigarette.

2. The aerosol-generating device of claim 1, wherein the controller is further configured to determine whether the inserted cigarette is the wet cigarette when a first time has elapsed since the heater started to be heated based on a preset first temperature profile.

3. The aerosol-generating device of claim 1, wherein the controller is further configured to determine whether the inserted cigarette is the wet cigarette based on a temperature increase rate of the heater when a first time has elapsed since the heater started to be heated.

4. The aerosol-generating device of claim 1, wherein the controller is further configured to determine whether the inserted cigarette is the wet cigarette based on the temperature of the heater when a first time has elapsed since the heater started to be heated.

5. The aerosol-generating device of claim 1, further comprising at least one capacitor disposed adjacent to the cigarette insertion hole such that capacitance of the capacitor varies with an amount of moisture in the cigarette inserted into the cigarette insertion hole,
wherein the controller is further configured to determine whether the inserted cigarette is the wet cigarette based on the capacitance.

6. The aerosol-generating device of claim 1, wherein the controller is further configured to, based on the inserted cigarette being the wet cigarette, select the dedicated temperature profile from among a plurality of preset dedicated temperature profiles based on an amount of moisture contained in the cigarette.

7. The aerosol-generating device of claim 1, wherein the controller is further configured to detect a time of recent use of the aerosol-generating device, and based on the time of recent use being within a certain time period, control the temperature of the heater based on a second dedicated temperature profile that is different from the dedicated temperature profile.

8. The aerosol-generating device of claim 7, wherein the controller is further configured to detect the time of recent use based on the temperature of the heater when the cigarette is inserted.

9. The aerosol-generating device of claim 7, wherein the controller is further configured to control the temperature of the heater based on the second dedicated temperature profile if the temperature of the heater when the cigarette is inserted is in a range of about 50 degrees Celsius to about 150 degrees Celsius.

10. The aerosol-generating device of claim 1, wherein the dedicated temperature profile is calculated by adjusting a basic temperature profile for a regular cigarette.

11. The aerosol-generating device of claim 10, wherein the dedicated temperature profile is calculated by delaying a point in time when the temperature of the heater reaches a maximum value in the basic temperature profile.

12. A method of controlling a temperature of a heater of an aerosol-generating device, the method comprising:
detecting that a cigarette is inserted into a cigarette insertion hole;
determining whether the inserted cigarette is a wet cigarette; and
controlling the temperature of the heater with a dedicated temperature profile corresponding to the wet cigarette based on the inserted cigarette being a wet cigarette.

13. The method of claim 12, further comprising detecting a time of recent use of the aerosol-generating device,
wherein the controlling of the temperature of the heater includes, based on the time of recent use being within a certain time period, controlling the temperature of the heater based on a second dedicated temperature profile that is different from the dedicated temperature profile.

14. The method of claim 12, wherein the dedicated temperature profile is a temperature profile calculated by adjusting a basic temperature profile for a regular cigarette.

15. A non-transitory computer-readable recording medium storing a program for executing the method of claim 12.
